(19) United States
(12) Patent Application Publication
(10) Pub. No.: US 2006/0198682 A1
(43) Pub. Date: Sep. 7, 2006

(54) Ribbon for printing apparatus, printing apparatus using this ribbon, and method for detecting ribbon type

(75) Inventor: Kaoru Tsuchiya, Daito City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/367,275

(22) Filed: Mar. 6, 2006

(30) Foreign Application Priority Data
Mar. 7, 2005 (JP) 2005-061835

(51) Int. Cl. B41J 31/00; B41J 17/32; B41J 35/36

(52) U.S. Cl. 400/240.3; 400/240.4

(57) ABSTRACT

In a ribbon for a printing apparatus in which a plurality of color ink sections 66a, 66b, and 66c corresponding to color printing are arranged along a lengthwise direction, a first detection mark corresponding to a printing characteristic of the ribbon is attached to a leading area of the ink section 66a to be printed first. Sensor units S1 and S2 for reading the first detection mark and a controller 1 for receiving a signal from the sensor units S1 and S2 and carrying out printing control corresponding to a printing characteristic of the ribbon are provided in the apparatus main body 3.

### BACKGROUND OF THE INVENTION

1. Field of the Invention

The present invention relates to ribbons used in printing apparatuses, specifically in thermal printing apparatuses, printing apparatuses that use these ribbons, and methods for detecting types of these ribbons.

2. Description of the Related Art

Thermal printing apparatuses such as thermal transfer printing apparatuses and thermal sublimation printing apparatuses have been proposed that print image data from personal computers and digital cameras and the like onto recording paper. To print an image onto recording paper, these thermal printing apparatuses use an ink cartridge 6 shown in FIG. 10 that detachably inserts inside the apparatus.

In one of these, a take-up roller 64 and a feed roller 61 are arranged separated by an interval inside a cartridge main body 60, and an ink ribbon 62 is placed extending between the rollers 61 and 64. A recording sheet 40 is positioned below the ink ribbon 62 and a thermal head 5 is positioned above the ink ribbon 62. An opening 63 is provided on the cartridge main body 60 between the rollers 61 and 64, and the thermal head 5 heats the ink ribbon 62 through the opening 63 such that the ink on the ink ribbon 62 is transferred or sublimated to the recording sheet 40.

FIG. 11 is a perspective view showing the rollers 61 and 64. Ink sections 66a, 66b, and 66c of the three colors yellow Y, magenta M, and cyan C are coated separately in order along the take-up direction on the ink ribbon 62. The recording sheet 40 is moved parallel to the ink ribbon take-up direction by a platen roller (not shown in the drawing). The thermal head 5 is connected to an image processing circuit 50 and image information corresponding to the colors yellow, magenta, and cyan is sent from the image processing circuit 50 to the thermal head 5.

At the commencement of printing, the leading area of the yellow ink section 66a is in opposition to the leading area of the recording sheet 40. During printing, the recording sheet 40 is carried by the platen roller, the ink ribbon 62 is wound in, and an image corresponding to yellow is printed. When the platen roller rotates approximately one time, the leading area of the recording sheet 40 becomes in opposition to the leading area of the magenta ink section 66b, and an image corresponding to magenta is printed. An image corresponding to cyan is printed in the same manner. As a technique for detecting the leading area of an ink section, a technique is known of directing a light onto the ink sections and detecting the leading area of each ink section from differences in optical reflectance of the colors using a photo-sensor.

The ink ribbon 62 is formed by applying the ink sections to a film made of synthetic resin, specifically, a film made of PET, but the printing characteristics of the inks and the film vary depending on the manufacturer of the ink cartridge 6 and the ink ribbon 62. Specifically, even when heated by the thermal head 5 at the same temperature, the extent to which the ink adheres to the recording sheet 40 varies depending on the type of the ink ribbon 62. Furthermore, the film is pulled when the ink ribbon 62 is carried, but the condition of film stretching varies depending on the manufacturer of the ink ribbon 62. For example, even when a film is pulled with the same tensile force, the film of a particular manufacturer may stretch 5% and the film of another manufacturer may stretch 10%. Due to this, the density of ink on the surface of the film varies at the time of printing.

Accordingly, a technique is known of applying a code label 69 (see FIG. 10), on which the characteristics of the relevant ink and film are recorded, to an outer surface of the cartridge main body 60. When the cartridge main body 60 is mounted inside the thermal recording apparatus, information of the code label 69 is read by a reading means (not shown in the drawing) inside the apparatus and the printing characteristics of the ink ribbon 62 are distinguished. In response to these printing characteristics, the temperature of the thermal head 5 is adjusted for example, or the tensile force of the film is adjusted.

However, these conventional methods have the following problems.

The following faults are encountered in methods for detecting the leading area of the ink sections 66a, 66b, and 66c from differences in the optical reflectance of each color. The difference in optical reflectance caused by colors is slight and to distinguish slight differences in optical reflectance it is necessary to optimally set the photo-sensor output and to suppress with good accuracy the unevenness in the densities of the ink sections 66a, 66b, and 66c and therefore factors such as selecting photo-sensors have been difficult. Furthermore, during carrying of the ink ribbon 62, the ink ribbon 62 may sometimes curl, and when this curling occurs, the leading areas of the ink sections 66a, 66b, and 66c may be incorrectly distinguished. To eliminate this risk it has been necessary to devise ways of increasing the signal detection capabilities of the photo-sensors, but this may result in reducing leeway in the design of the apparatuses.

Furthermore, in methods for reading information of the code label 69 using a reading means inside the apparatus, there is the problem that the structure of the apparatus becomes complicated since it is necessary to arrange the reading means inside the apparatus. Furthermore, since the code label 69 is provided on an outer surface of the cartridge main body 60, it may be touched by the fingerprints of the user and the code label 69 may be damaged during handling, so that there is a problem of it being distinguished with reduced precision.

### SUMMARY OF THE INVENTION

According to the preferred embodiments, ribbon, apparatus, and method are provided, capable of accurately distinguishing the leading areas of the ink sections 66a, 66b, and 66c and the printing characteristics of the ink ribbon 62 using a simple structure.

A plurality of color ink sections 66a, 66b, and 66c corresponding to color printing are arranged along a lengthwise direction, and a first detection mark corresponding to a printing characteristic of the ribbon is attached to a leading area of the ink section 66a to be printed first. The first detection mark includes printing commencement information of the ribbon and control information corresponding to the printing characteristics of the ribbon.

A sensor for reading the first detection mark and a controller 1 for receiving a signal from the sensor and carrying out printing control corresponding to the printing characteristics of the ribbon are provided in the apparatus main body 3 of the printing apparatus.

Furthermore, the first detection mark indicates that printing is to be performed first, and a second detection mark for distinguishing a color different from the first detection mark is attached at a leading area of the ink sections 66b and 66c to be printed after the ink section 66a, which is to be printed first.

At the time of printing, the first detection mark of the ink ribbon 62 is detected by the sensor and the printing characteristics of the ink ribbon 62 are distinguished. Accordingly, the printing characteristics can be distinguished using a simple structure.

Furthermore, which color of the ink sections 66a, 66b, and 66c the sensor is opposing is recognized by detecting the second detection mark after the first detection mark is detected, and therefore in this regard too it is possible to distinguish the ink sections 66a, 66b, and 66c that the sensor is opposing using a simple structure. The first and second detection marks are attached to the ink ribbon 62 and even if the ink ribbon 62 inside the cartridge main body 60 is replaced, the printing characteristics can be distinguished in the same manner and the ink sections 66a, 66b, and 66c that the sensor is in opposition to can be distinguished.

### BRIEF DESCRIPTION OF THE DRAWINGS

FIG. 1 is an exploded perspective view of a thermal recording apparatus;

FIG. 2 is front view of FIG. 1;

FIG. 3 is a front view of a platen roller;

FIG. 4 is a front view showing a vicinity of an ink cartridge inside an apparatus main body;

FIG. 5 is a lateral view of FIG. 4 as seen from a direction A;

FIG. 6 is an internal block diagram of the apparatus main body;

FIGS. 7A to 7C are plan views of ink ribbons;

FIG. 8 is a table showing output of sensor units S1 and S2;

FIG. 9 is a flowchart showing a printing control operation;

FIG. 10 is a perspective view of a conventional ink cartridge; and

FIG. 11 is a perspective view showing rollers inside the cartridge.

### DETAILED DESCRIPTION OF PREFERRED EMBODIMENTS

Hereinafter, an embodiment of the present invention is described using the accompanying drawings.

Overall Structure

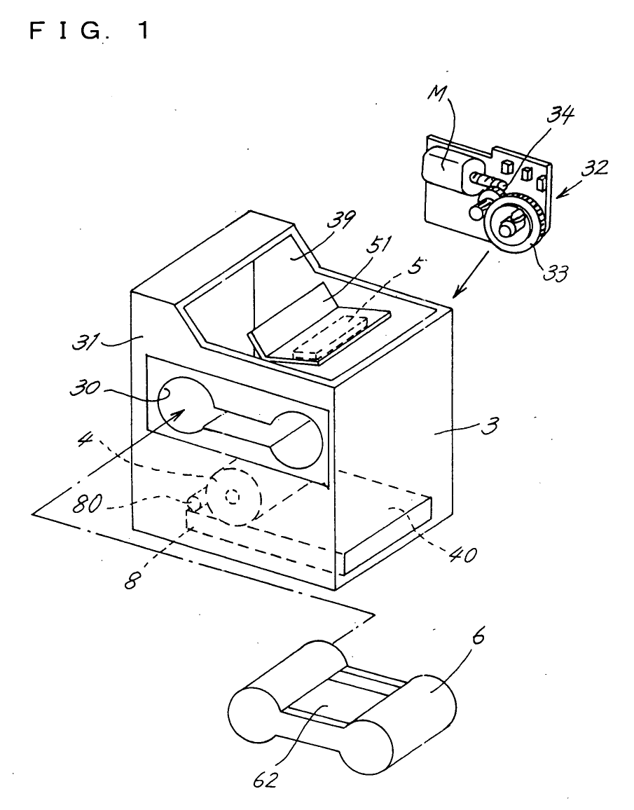

FIG. 1 is an exploded perspective view of a thermal recording apparatus. At a side panel 31 of the apparatus main body 3, a pass-through aperture 30 is opened into which the ink cartridge 6 inserts, and a platen roller 4 around which winds the recording sheet 40 and a supply tray 8 that contains the recording sheets 40 are positioned below the pass-through aperture 30.

A support plate 51, which is provided with a thermal head 5 and also functions as a heat sink, is provided pivotably inside the apparatus main body 3 above the pass-through aperture 30. As is well known, the thermal head 5 heats the ink ribbon 62 inside the ink cartridge 6 to sublimate the ink and print an image on the recording paper 40. As for the ink cartridge 6, in the same manner as conventionally, a take-up roller 64 and a feed roller 61 are arranged inside the cartridge main body 60, and an ink ribbon 62 is placed extending between the rollers 61 and 64.

A take-up roller drive unit 32 provided with a reel mount 33 is provided at an inner section of the apparatus main body 3. The reel mount 33 allows the take-up roller 64 to rotate and wind up the ink ribbon 62. The take-up roller drive unit 32 is provided with a gear train 34, which is meshed with a motor M and the reel mount 33, and the reel mount 33 rotates when power is delivered to the motor M.

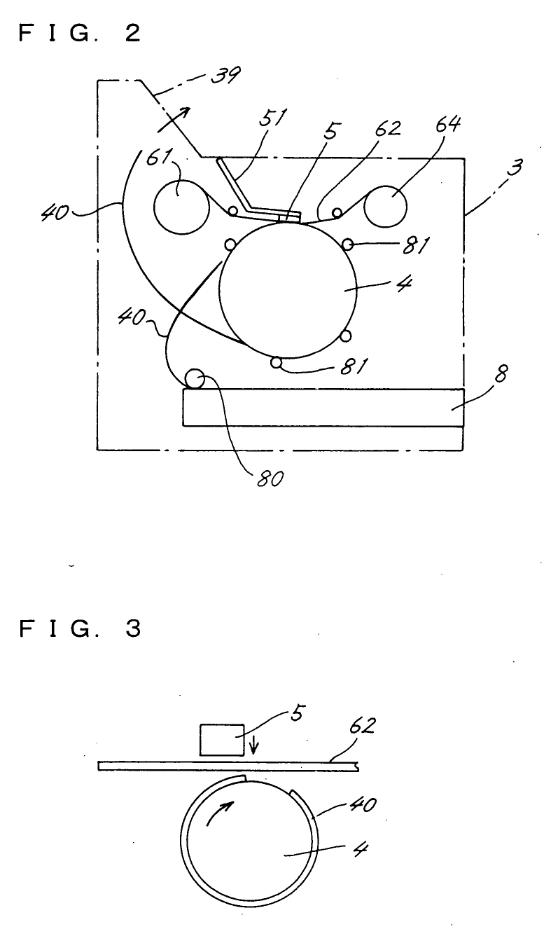

FIG. 2 is a front view of FIG. 1 showing an outline of the overall structure. For convenience of illustration, the cartridge main body 60 is not shown in FIG. 2. Furthermore, FIG. 3 is a front view of the platen roller 4. The recording sheets 40 in the supply tray 8 are taken out sheet by sheet by a pick up roller 80 and the recording sheet 40 winds onto the platen roller 4 the same as conventionally. The platen roller 4 is rotated and the ink ribbon 62 is heated by the thermal head 5 while being carried by the take-up roller 64 such that image information of yellow, magenta, and cyan is printed in order on the recording sheet 40. Specifically, at the commencement of printing, the leading area (see FIG. 7A) of the yellow ink section 66a is in opposition to the leading area of the recording sheet 40. When the platen roller rotates approximately one time, the leading area of the recording sheet 40 becomes in opposition to the leading area of the magenta ink section 66b, and an image corresponding to magenta is printed. After this, an image corresponding to cyan is printed in the same manner. As is described later, a transparent section called an overcoat section 66d is provided after the cyan ink section 66c on the ink ribbon 62. When printing is finished, the recording sheet 40 is discharged from a discharge section 39 formed at an upper end area of the apparatus main body 3 by a carry roller 81.

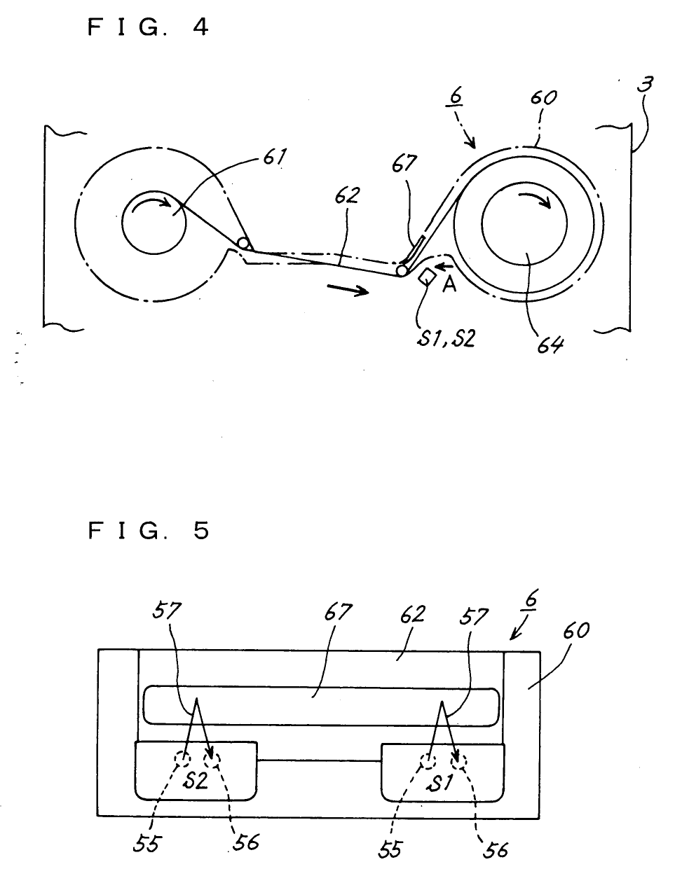

FIG. 4 is a front view showing a vicinity of the ink cartridge 6 inside the apparatus main body 3 and FIG. 5 is a lateral view of FIG. 4 as seen from a direction A. In the apparatus main body 3, two sensor units S1 and S2 are arranged along a depth direction of the apparatus main body 3 underneath the carry path of the ink ribbon 62 and a reflective sticker 67 that reflects a light 57 from the sensor units S1 and S2 is provided on the other side of the cartridge main body 60.

Each of the sensor units S1 and S2 is provided with a light-emitting section 55 and a light-receiving section 56, and when the light from the light-emitting section 55 passes through the ink ribbon 62, is reflected by the reflective sticker 67, and received by the light-receiving section 56, the sensor units S1 and S2 output an L (low). When the light from the light-emitting section 55 is absorbed by the ink ribbon 62 and is not received by the light-receiving section 56, the sensor units S1 and S2 output an H (high).

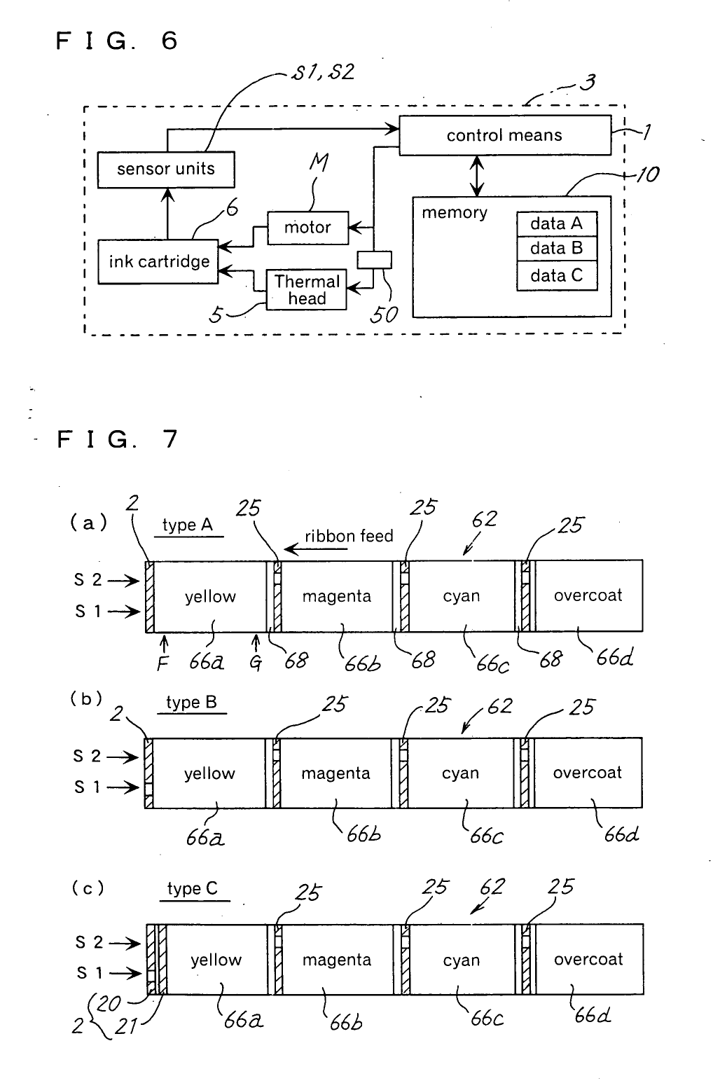

FIG. 6 is an internal block diagram of the apparatus main body 3. The sensor units S1 and S2 are connected to a control means 1, which is an ASIC, and this control means 1 is connected to a memory 10 in which data A, B, and C is stored corresponding to printing characteristics of types of ink ribbons. The control means 1 is connected to the thermal head 5 via the motor M and the image processing circuit 50, and controls the ascent/descent and heating temperature (approximately 300° C.) of the thermal head 5, the rotational speed of the motor M, and the drive torque. The pulling force on the ink ribbon 62 inside the ink cartridge 6 is adjusted by controlling the drive torque of the motor M. It should be noted that the control means 1 also controls such factors as the rotation of the platen roller 4, but description of this is omitted here.

FIGS. 7A, 7B, and 7C are plan views of the ink ribbon 62 and show examples of three types of ink ribbon, namely a type A, type B, and a type C. The printing characteristics of the three types of ink ribbon 62 type A, type B, and type C correspond respectively to the data A, B, and C inside the memory 10. Of course, the ink ribbon 62 is not limited to these three types. In the ink ribbon 62, the yellow, magenta, and cyan ink sections 66a, 66b, and 66c are arranged along the ribbon feed direction the same as conventionally, and a detection mark is attached at the leading area of each of the ink sections 66a, 66b, and 66c. The overcoat section 66d, in which a substantially transparent material is applied, is provided after the cyan ink section 66c, and after printing of the three colors is finished, the printed surface is protected and given glossiness by covering the printed surface of the recording sheet 40 with the substantially transparent material of the overcoat section 66d.

The detection marks positioned at the leading area of the yellow ink section 66a, which is the color to be printed first, of the three types of ribbon type A, type B, and type C are different, and these marks are referred to as a first detection mark 2, and the detection marks positioned at the leading areas of the ink sections 66b and 66c, which are to be printed thereafter (namely, magenta and cyan) and the overcoat section 66d are referred to as second detection marks 25.

The first detection mark 2 is different at the three types of ink ribbon 62, and therefore when the control means 1 obtains information of the first detection mark 2 from the sensor units S1 and S2 as will be described later, the type of the ink ribbon 62 (for example, which manufacturer) and the fact that the leading area of the yellow ink section 66a is in opposition to the sensor units S1 and S2 are detected.

The second detection marks 25 are of line shapes that extend in a width direction (a direction orthogonal to the length direction) on the ink ribbon 62 and a location thereof in opposition to the sensor unit S1 is black and a location thereof in opposition to the sensor unit S2 is transparent. The black location absorbs light from the light-emitting section 55 and therefore as mentioned before, when the sensor units S1 and S2 are in opposition to the black location, the sensor units S1 and S2 output an H.

On a single ink ribbon 62, three of the second detection marks 25 are provided corresponding to the magenta and cyan ink sections 66b and 66c and the overcoat section 66d. The three second detection marks 25 are the same pattern, that is, the same width and length.

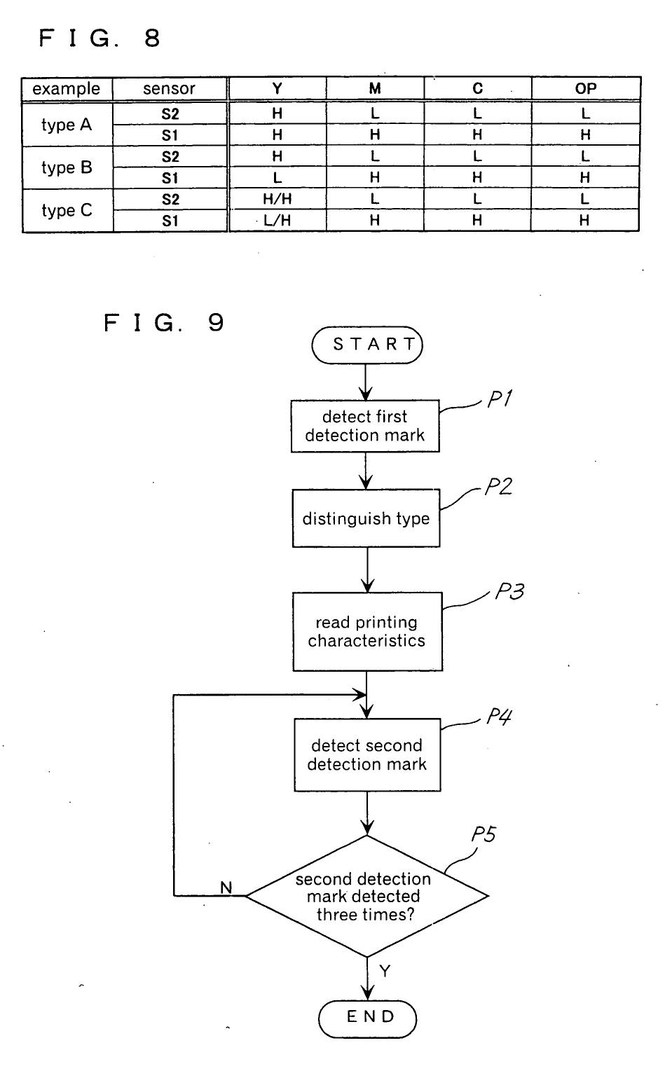

FIG. 8 is a table showing output of the sensor units S1 and S2 and Y, M, and C indicate yellow, magenta, and cyan respectively, while OP indicates the overcoat section 66d. The sensor unit S1 is in opposition to the black location and the sensor unit S2 is in opposition to the transparent location when the second detection mark 25 is detected, and therefore the output of the step S1 is H and the output of the sensor unit S2 is L. The second detection marks 25 are the same on the three types of the ink ribbon 62 and the sensor units S1 and S2 output the same signal when the second detection mark 25 is detected.

The first detection marks 2 shown in FIGS. 7A, 7B, and 7C are of line shapes extending in the width direction of the ink ribbon 62, but have a different pattern shape than the second detection marks 25. In the case of type A, the locations opposing the sensor units S1 and S2 are both black. In the case of type B, the location opposing the sensor unit S1 is transparent and the location opposing the sensor unit S2 is black.

In the case of type C, the first detection mark 2 is provided with two line shape areas 20 and 21, which extend in the width direction of the ink ribbon 62, and are close to each other along the length direction of the ink ribbon 62. In regard to the line shape area 20 positioned on the ribbon feed side, the location opposing the sensor unit S1 is transparent and the location opposing the sensor unit S2 is black. And in regard to the line shape area 21, which is positioned on an opposite side to the ribbon feed side, the locations opposing the sensor units S1 and S2 are both black.

When the sensor units S1 and S2 detect the first detection mark 2 of the type A ink ribbon 62 in FIG. 7A, the sensor units S1 and S2 are in opposition to the black areas, and therefore the sensor units S1 and S2 both output H.

And similarly, when the sensor units S1 and S2 detect the first detection mark 2 of the type B ink ribbon 62, the output of the sensor unit S1 is L and the output of the sensor unit S2 is H. When the first detection mark 2 of the type C ink ribbon 62 is detected, the output of the sensor unit S1 is L/H, that is, L is followed by H, and the output of the sensor unit S2 is H/H, that is, H continues two times. In the data A, B, and C inside the memory 10 there is information associated with the output of the sensor units S1 and S2.

The output when the sensor units S1 and S2 detect the first and second detection marks 2 and 25 is not limited to that described above. However, as described earlier, the overcoat section 66d is transparent and when the sensor units S1 and S2 become in opposition to the overcoat section 66d, both the sensor units S1 and S2 output L. Consequently, the output when the sensor units S1 and S2 detect the detection marks 2 and 25 cannot both be L.

At the commencement of printing, the thermal head 5 in FIG. 3 is apart from the ink ribbon 62. Using the type A ink ribbon 62 in FIG. 7A as an example, when the sensor units S1 and S2 detect the first detection mark 2, the control means 1 rotates the motor M to feed the ink ribbon 62 and lowers the thermal head 5. Before the completion of the descent of the thermal head 5, the ink ribbon 62 is fed, and printing commences from the point F in FIG. 7A. When the platen roller 4 rotates approximately one time, the thermal head 5 becomes positioned at the point G in FIG. 7A and the control means 1 raises the thermal head 5. When the sensor units S1 and S2 detect the second detection mark 25, the control means 1 again lowers the thermal head 5.

That is, leeway is provided with respect to the actual rotation distance of the platen roller 4 to ensure printing with the ink sections 66a, 66b, and 66c. In order to save ink and achieve reduced costs, it is common for a white margin 68 to be provided between the second detection mark 25 and the immediately preceding ink sections 66a and 66b and the overcoat section 66d.

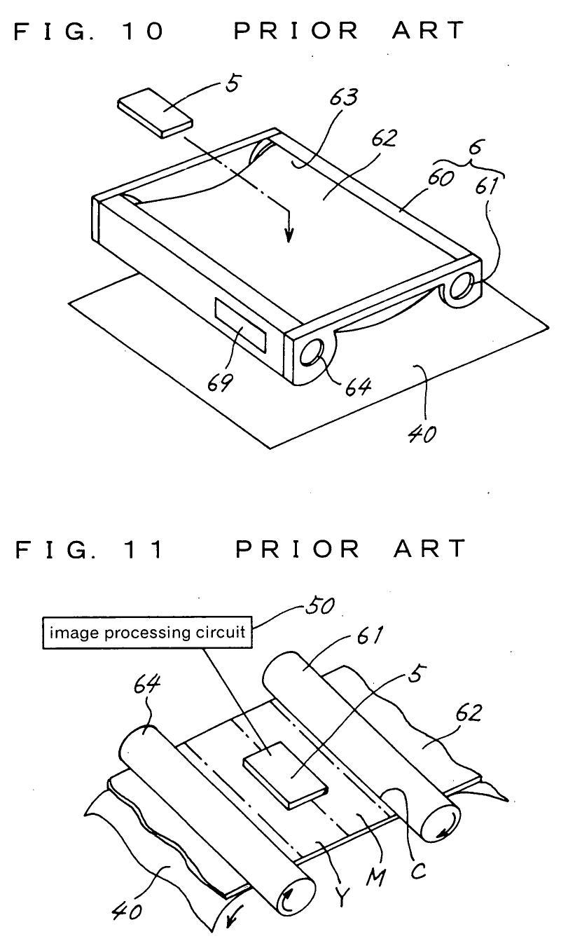

The following is a description of a printing control operation using the flowchart of FIG. 9.

First, the ink cartridge 6 is mounted in the apparatus and a printing standby condition begins when the power is turned on. At the commencement of printing, the first detection mark 2 on the ink ribbon 62 is in opposition to the sensor units S1 and S2. The sensor units S1 and S2 emit a light onto the first detection mark 2 and the control means 1 distinguishes (P1, P2) which of the types A, B, and C the ink ribbon 62 is from the output of the sensor units S1 and S2 and the information of the types A, B, and C in the memory 10. At the same time, it is also determined that the sensor units S1 and S2 are in opposition to the leading area of the yellow ink section 66a. The control means 1 reads the printing characteristics of the detected type from the memory 10 (P3). Next, the control means 1 controls printing according to the printing characteristics data, specifically, it adjusts the temperature of the thermal head 5, and supplies power to the motor M so that the ink ribbon 62 is wound up with a desired torque. The image processing circuit 50 sends image data corresponding to yellow to the thermal head 5. When the platen roller 4 rotates approximately one time, the thermal head 5 is raised.

When the second detection mark 25 is detected (P4) from the output of the sensor units S1 and S2, the control means 1 lowers the thermal head 5, but since this is the first time the second detection mark 25 is detected after the first detection mark 2, the fact that the sensor units S1 and S2 are in opposition to the leading area of the magenta ink section 66b is recognized. The image processing circuit 50 sends image data corresponding to magenta to the thermal head 5.

Thereafter, when the second detection mark 25 is detected a second time, the fact that the sensor units S1 and S2 are in opposition to the leading area of the cyan ink section 66c is detected, and when detection occurs a third time, the fact that the sensor units are in opposition to the leading area of the overcoat section 66d is detected. Printing of the image is completed after the second detection mark 25 has been detected a third time (P5), and therefore printing is finished after the printed image is covered by a coating of the overcoat section 66d.

In the present example, the first detection mark 2 of the ink ribbon 62 is detected by the sensor units S1 and S2 and the printing characteristics of the ink ribbon 62 are distinguished, and therefore the printing characteristics can be distinguished using a simple structure. Furthermore, which color of the ink sections 66a, 66b, and 66c the sensor units S1 and S2 are opposing is recognized by counting the number of second detection marks 25, and therefore in this regard too it is possible to distinguish the ink sections 66a, 66b, and 66c that the sensor units S1 and S2 are opposing using a simple structure. There is no alteration to the shape of the ink cartridge 6 or the like and the sensor units S1 and S2 are also the same as those that have conventionally existed.

Furthermore, applying color to the detection marks using a black color that has low reflectivity, that is, absorbs light ensures that the leading areas of the ink sections 66a, 66b, and 66c are detected. For example, during carrying of the ink ribbon 62, the ink ribbon 62 may sometimes curl, but there is no risk of incorrect distinguishing of the leading areas of the ink sections 66a, 66b, and 66c even if this curling occurs and the sensor units S1 and S2 are not completely opposing the ink ribbon 62. In this way, there is increased freedom in the positioning and designing of the apparatuses of the sensor units S1 and S2.

In particular, the overcoat section 66d has high transparency and the light from the sensor units S1 and S2 is easily reflected by the reflective sticker 67, but the detection marks that are colored black can be detected regardless of the presence or absence of the overcoat section 66d. Moreover, the diameter of the wound take-up roller 7 changes along with the taking up of the ink ribbon 62. Consequently, although the distance between the ink ribbon 62 and the sensor units S1 and S2 changes, by coloring the detection marks black there is no hindrance to detecting the detection marks even when this distance changes.

When the ink ribbon 62 has undergone printing once and has been wound up, it cannot be used again. As a general rule in this case, the used ink cartridge 6 is discarded, but it is also possible to keep the cartridge main body 60 and replace only the ink ribbon 62, which is the content thereof. In this case, an ink ribbon 62 having different printing characteristics than the previously used ribbon may replace that ribbon. Even when a ribbon is replaced by an ink ribbon 62 having different printing characteristics, appropriate printing control can be achieved by detecting the first and second detection marks 2 and 25.

In the above-described example, the sensor units S1 and S2 were illustrated by an example of optical sensors, but an infrared sensor may also be used for example.

What is claimed is:

1. A ribbon for a printing apparatus, comprising:
a plurality of color ink sections corresponding to color printing are arranged along a lengthwise direction;
a first detection mark corresponding to a printing characteristic of the ribbon is attached at a leading area of the ink section to be firstly printed; and
the first detection mark including printing commencement information of the ribbon and control information corresponding to the printing characteristic of the ribbon.

2. A ribbon for a printing apparatus, comprising:
a plurality of color ink sections corresponding to color printing are arranged along a lengthwise direction;
a first detection mark indicating that printing is to be performed first is attached at a leading area of the ink section to be firstly printed; and
a second detection mark for distinguishing a color different from the first detection mark is attached at a leading area of the ink section to be printed thereafter.

3. The ribbon according to claim 1, wherein a black color having a low optical reflectance is applied to the detection marks.

4. The ribbon according to claim 2, wherein a black color having a low optical reflectance is applied to the detection marks.

5. A printing apparatus, comprising:
an ink cartridge containing an ink ribbon is detachably mounted inside an apparatus main body;
the ink ribbon having a plurality of color ink sections arranged along a lengthwise direction;
and a first detection mark corresponding to a printing characteristic of the ribbon is attached at a leading area of the ink section to be firstly printed;
the first detection mark including printing commencement information of the ribbon and control information corresponding to the printing characteristic of the ribbon; and
a sensor portion for reading the first detection mark and a control means for receiving a signal from the sensor means and carrying out printing control corresponding to a printing characteristic of the ribbon are provided in the apparatus main body.

6. A printing apparatus, comprising:
an ink cartridge containing an ink ribbon is detachably mounted inside an apparatus main body;
the ink ribbon having a plurality of color ink sections arranged along a lengthwise direction,
a first detection mark indicating that printing is to be performed first is attached at a leading area of the ink section to be firstly printed,
and a second detection mark for distinguishing a color different from the first detection mark is attached at a leading area of the ink section to be printed thereafter;
a sensor portion for reading both the detection marks;
and a control portion for receiving a signal from the sensor portion and distinguishing the color of the ink section are provided in the apparatus main body.

7. The printing apparatus according to claim 6, wherein a plurality of same second detection marks are provided corresponding to colors and the control means distinguishes the color of the ink section from the number of the second detection marks that are detected after detection of the first detection mark.

8. A method for detecting a ribbon type for a printing apparatus in which a plurality of color ink sections corresponding to color printing are arranged along a lengthwise direction,
the method comprising:
a step of reading a first detection mark, and
a step of carrying out printing control corresponding to the printing characteristic of a ribbon from the first detection mark of the ribbon.
wherein the first detection mark corresponding to a printing characteristic of the ribbon is attached at a leading area of the ink section to be firstly printed, the first detection mark including printing commencement information of the ribbon and control information corresponding to the printing characteristic of the ribbon.
